(19) United States
(12) Patent Application Publication
(10) Pub. No.: US 2020/0013003 A1
(43) Pub. Date: Jan. 9, 2020

(54) SYSTEM AND METHOD FOR DEPLETION PREDICTION OF CONSUMER-PACKAGED GOODS USING MOTION SENSORS

(71) Applicant: Candibell, Inc., Andover, MA (US)

(72) Inventor: Lunan Gao, Andover, MA (US)

(73) Assignee: Candibell, Inc., Andover, MA (US)

(21) Appl. No.: 16/410,215

(22) Filed: May 13, 2019

Related U.S. Application Data
(63) Continuation-in-part of application No. 16/137,835, filed on Sep. 21, 2018.
(60) Provisional application No. 62/731,191, filed on Sep. 14, 2018.
(60) Provisional application No. 62/742,490, filed on Oct. 8, 2018.
(60) Provisional application No. 62/684,770, filed on Jun. 14, 2018.

(51) Int. Cl. G06Q 10/08; H04W 4/38; H04W 4/35; G01P 15/14

(52) U.S. Cl. CPC G06Q 10/087; G01P 15/14; H04W 4/35; H04W 4/38

(57) ABSTRACT

A system and method uses low cost and power efficient motion sensors integrated into (or attach to) a broad range of general Consumer Packaged Goods (CPG) containers or packages to learn and recognize a consumer's gesture(s) during a consumption event. Sensory inputs from motion sensors, such as an accelerometer, a compass, and/or a gyroscope are provided to a depletion prediction model/program which maps past consumption events to determine a percentage of quantity of the good(s) remaining in the CPG. The depletion prediction model may take into consideration the individual consumer's habitual consumption rate and history. The depletion prediction model is updated continuously, or at specific time intervals, based on the input(s) from the motion sensors. The depletion prediction model can then be used to predict the quantity remaining for the CPG being tracked, allowing the system to further handle re-stocking with a retailer's online system.

### RELATED APPLICATIONS

The present application claims priority to U.S. Provisional Patent Application No. 62/731,191, Filed: Sep. 14, 2018, titled SYSTEM AND METHOD FOR ESTIMATING FOOD CONSUMPTION RATE AND PREDICTING DEPLETION USING BATTERY POWERED MOTION SENSORS, and U.S. Provisional Patent Application No. 62/742,490, Filed: Oct. 8, 2018, titled SYSTEM AND METHOD FOR DEPLETION PREDICTION OF CONSUMER-PACKAGED GOODS USING BATTERY POWERED MOTION SENSORS, which are incorporated by reference herein in their entireties.

### TECHNICAL FIELD

The present disclosure relates to a system and method for determining consumption of consumer-packaged goods (CPG).

### BACKGROUND

Consumer-packaged goods (“CPG”) retailers are constantly innovating ways they engage with consumers who today have more choices than ever before. New technologies, together with novel enhancements of the “buying experience” help retailers and brands to retain consumers and drive sales. In 2015, one electronic retailer launched a battery-powered, Wi-Fi based device allowing consumers to order a specific product from a brand with a push of a button. It quickly became the model of ubiquitous and omni-channel commerce that retailers and brands love—speedy purchases, satisfied consumer experiences, and improved brand loyalty all leading to significant increases in sales. Many consumers were thrilled with the experience and transactions through this channel quadrupled in 2017 from the previous year.

While the foregoing story has proved the importance of simplicity and speed in omni-channel commerce, this type of solution has several limitations. One of the obstacles is the cognitive burden of initiating a purchase. Albeit procedurally simple, the referenced solution requires the consumer to make a judgment and take an explicit action to make the purchase. This greatly limits its generalization to eventually support an always-available, consumer-optimized channel between a brand and a consumer. For example, the consumer cannot use the foregoing type of solution to setup a recurring ordering relationship with brands and retailers because the system does not know when to replenish until the consumer realizes the need and initiates the transaction.

Existing methods such as object and gesture recognition using cameras are handy in principle but pose serious reliability challenges in practice. Services have been launched to allow smart appliance vendors to build their own consumption meters. However, this approach requires each vendor to develop its own, specific monitoring system for quantity assessment and is therefore not a turn-key model that can be easily transformed and applied to many other CPGs and vendors.

The e-commerce sector is rapidly growing. With the success of the foregoing types of product/service offerings, more and more retailers and brands want to build an omni-channel commerce communication solution with their customers for improved loyalty, convenience and sales. Today, there lacks a simple and reliable method in this process to allow the consumer to automatically re-stock their goods when the goods become depleted. A recurring re-ordering strategy that is only based on time does not yield the best result since the time it takes for the old good to deplete varies for each shopping cycle and over time. Consumers want to consume fresh, newly produced goods, but fear gaps in their supply and the cognitive burden of remembering to re-order on time present challenges.

### SUMMARY

The present disclosure solves the problems of known solutions, such as gaps in supply and having to remember and affirmatively act to re-order on time, by implementing a system and method for utilizing motion sensors to estimate the consumption rate of consumer-packaged goods (CPG) as well as predict remaining quantity of CPGs. The disclosed system and method uses low cost and power efficient motion sensors that require minimal footprints on a PCB, and that can be effortlessly integrated into (or attach to) a broad range of general CPG containers or packages. The sensors are programmed to learn and recognize a consumer's gesture(s) during a consumption event using sensory inputs from motion sensors, such as an accelerometer, a compass, and/or a gyroscope. A mathematical depletion prediction model may be implemented, according to the disclosure, which maps past consumption events to determine a percentage of quantity of the good(s) remaining. The depletion prediction model may take into consideration the individual consumer's habitual consumption rate and history. The depletion prediction model is updated continuously, or at specific time intervals, based on the sensory input(s) from the motion sensors. The model can then be used to predict the quantity remaining for the CPG being tracked, allowing the system to further handle re-stocking with a retailer's online system. The sensors may also include environmental sensors as described in commonly owned and co-pending U.S. patent application Ser. No. 16/137,835, which is incorporated herein by reference in its entirety. The system and method according to the disclosure may also estimate the expiration time of the good(s) using data from environmental sensors.

The disclosed system and method provides consumers an effective and affordable solution that alerts consumers before their favorite items deplete and can intelligently place a re-stocking order with a CPG vendor to have new replenishment items delivered to a consumer with no gap in their supply.

The foregoing and other advantages of the present disclosure will become more apparent to those skilled in the art from the following description of detailed embodiments of the disclosure that have been shown and described by way of illustration. As may be realized, the disclosed subject matter is capable of other and different embodiments, and its details are capable of modification in various respects.

### BRIEF DESCRIPTION OF THE DRAWINGS

Embodiments of devices, systems, and methods are illustrated in the figures of the accompanying drawings which are meant to be exemplary and non-limiting, in which like references are intended to refer to like or corresponding parts, and in which:

FIG. 1 illustrates the components of the disclosed system for monitoring consumption events according to the disclosure;

FIG. 2 illustrates a process flow diagram of an exemplary embodiment of the system to monitor a CPG target for a consumption event according to the disclosure;

FIG. 3 illustrates a process flow diagram for the detection of a consumption event using a further embodiment of the system according to the disclosure;

FIG. 4 illustrates a process flow diagram for monitoring a CPG target and determining when the CPG target will require replenishment according to the disclosure.

FIG. 5 illustrates a process flow diagram for monitoring the quantity and quality of a CPG target according to the disclosure.

### DETAILED DESCRIPTION

The detailed description of aspects of the present disclosure set forth herein makes reference to the accompanying drawings, which show various embodiments by way of illustration. While these various embodiments are described in sufficient detail to enable one skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in a different order and are not necessarily limited to the order presented. Moreover, references to a singular embodiment may include plural embodiments, and references to more than one component may include a singular embodiment.

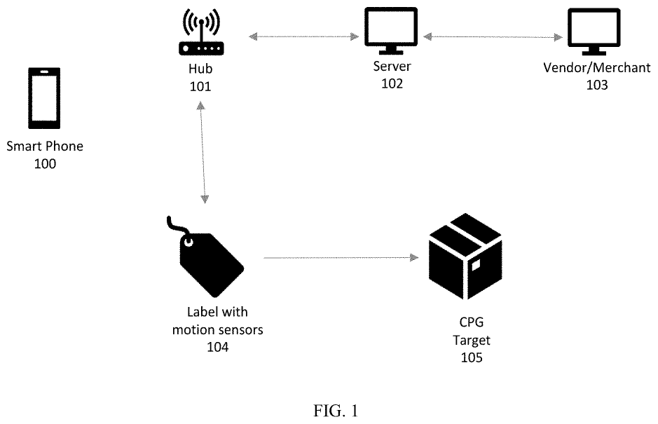

FIG. 1 illustrates the components of the disclosed system that monitors for consumption events. The system includes a smart label 104 with motion sensors configured to communicate with a server 102 to estimate and predict the depletion of a CPG target (referred to as “target,” or “CPG”) 105. To automate the monitoring process, a consumer may manually attach the label 104 to the target 105. Alternatively, an equivalent of the label 104 including motion sensors may be directly built into the CPG's 105 container or package. The manual attachment can take different forms depending on the specific shape and design of the label 104, and the target's 105 packaging. For example, a label 104 may be clamped, strapped, or glued, or otherwise attached onto the package of the target 105. The attachment may be secured so any movement of the target's 105 container or package will correspondingly cause the label 104 to move.

A consumer may configure the label 104 with information describing a set of gestures that are commonly associated with consuming a particular type of goods. Additionally, parameters used in the model that relate consumption events to the target's 105 remaining quantity may be pre-estimated and their initial values configured onto the label 104. Depending on the specific model and motion sensor type(s) used, these configurations and parameters may include but are not limited to the average number of consumption events in a full tracking session; thresholds of sensory inputs describing consumer gestures such as tilting, lifting, dropping, and panning; as well as the household size and/or average length of a tracking session for the type of goods to be monitored. The configuration of the label 104 may require the consumer to use a smartphone or device 100 to communicate with the label 104 such as with an RFID programming or Bluetooth Low Energy (BLE) application. Alternatively, the configuration may be first entered by the consumer via the smartphone or device 100 and be saved to a server 102 for retrieval by the label 104.

Once the label 104 is configured and securely attached to the target 105, the consumer may indicate the start of the tracking session by issuing a command to the label 104; for example, by pressing on a button on or sending a start signal to the label 104. While tracking is in session, the label's 104 motion sensor(s) continues to operate and provide inputs for the detection of consumer gestures to recognize consumption events. The gesture detection is based on pattern recognition from observed changes in orientation, angular velocity, and/or acceleration along 3-axis, or a combination thereof, of the target 105 or its package. Once a complete set of gestures relating to a consumption event is recognized, the label 104 informs the server 102 and the server 102 records details about the consumption event and updates its depletion prediction model. A complete set of gestures includes one or more gestures associated with a consumption event.

The label 104 may also include environmental sensors such as a thermometer, humidity sensor, light sensor, and other sensors key to monitoring the target's 105 holding environment. The holding environment may be compared to a data set regarding the target's 105 preferred or optimal holding conditions for greatest longevity or “best when used by” conditions, to determine when a significant deviation occurs.

The server 102 maintains a running model which keeps track of the consumption events detected since the beginning of the tracking session. The state of the model is updated as more consumption events are recognized and as time lapses. The model can be used to predict how much of the target 105 remains by taking into consideration historical data on consumption, the user's habits, and the model's state in the present tracking session. If the model determines that the quantity remaining is low, it can issue a warning to the consumer's smartphone or device 100, as well as automatically place a re-stocking order with a vendor 103 to replenish the goods.

A tracking session may be stopped by the consumer by issuing a command to the label 104, for example, by double-pressing on a button on the label 104 or otherwise sending an end-session signal. When this occurs, the label 104 sends a notification to the server 102 and the server 102 stops the corresponding model that is used to track the target 105. Key model parameters such as the average tracking session length, and the total number of consumption events are updated according to a rule set described herein.

The communication between the label 104 and a hub 101 uses wireless technology such as Bluetooth Low Energy (BLE) or Zigbee. If the label 104 uses Wi-Fi to communicate with the server 102, the hub 101 is deemed a Wi-Fi access point. Other wireless technologies can be similarly utilized as the transportation technology without deviating from the disclosure. Multiple hubs 101 may be deployed to increase reception and coverage, and thereby minimize data loss during wireless communication with multiple labels 104. Each hub 101 communicates with the server 102 through LAN and Wi-Fi. The server 102 can perform aforementioned depletion modeling and prediction in the cloud, on behalf of a consumer for multiple targets 105 at the same time. Modeling results, alerts, and descriptive information can be sent to the consumer's smartphone or device 100 when needed. The server 102 communicates with the vendor 103 to place and manage a new/existing re-stocking order and delivery.

### Motion Sensors

A label 104 may be equipped with a number of motion sensors to detect a consumption event. These sensors are typically lightweight, low-power, and resistant to environmental changes. A sensor may optimally have a small footprint to enable securing to a printed circuit board (PCB) or flex circuit of the label 104 as an electronic component. Alternatively, the label 104 may be built into a CPG package.

An illustrative embodiment of the disclosure may include an accelerometer, a compass, and a gyroscope to detect consumption events. The label 104 may also be equipped with environmental sensors for monitoring the quality of the target 105 in addition to the quantity remaining. Environmental sensors are described in further detail in co-pending U.S. patent application Ser. No. 16/137,835, which is incorporated herein by reference in its entirety.

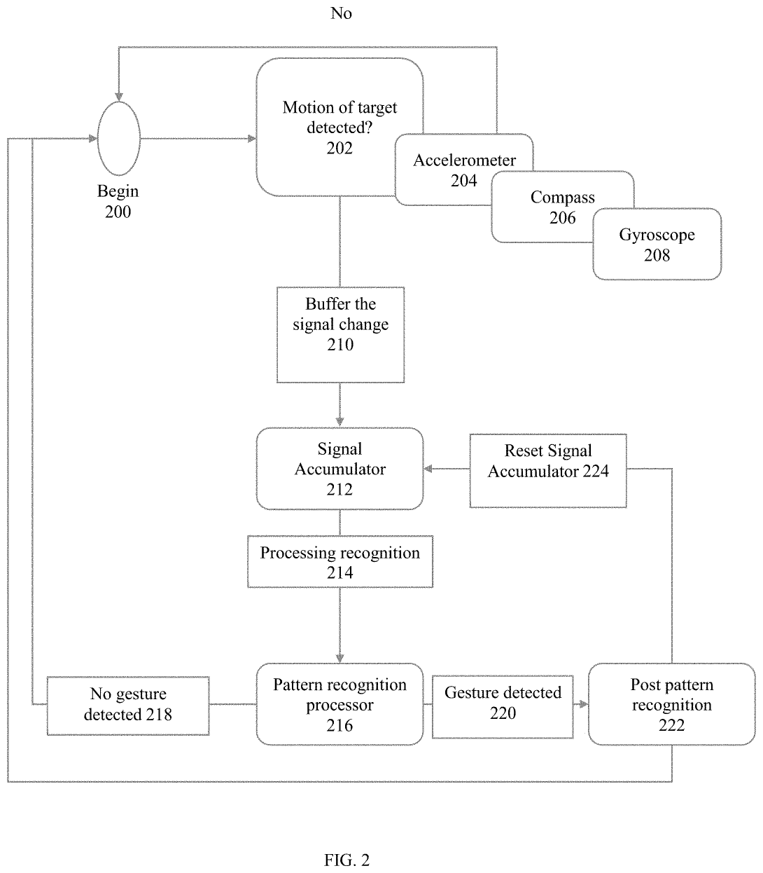

FIG. 2 illustrates a process flow diagram of an illustrative embodiment of the system and method to monitor a CPG target 105 for a consumption event according to the disclosure. The system begins 200 a tracking session and monitors 202 the target 105 for consumption events.

An illustrative embodiment of a label 104 may include an accelerometer 204 as a motion sensor. An accelerometer 204 is a device that measures acceleration. The accelerometer 204 measures the linear acceleration of the target 105 and its container or package when the consumer performs at least one of a sequence of gestures such as lifting, tilting, moving, and dropping.

Industrial Micro-Electro-Mechanical System (MEMS) types of accelerometers can be used as they are configured to be ultra-low power and highly sensitive with three-axis linear acceleration outputs. Advanced techniques such as a FIFO buffer allow sensory data to be stored to limit intervention by host processors, further reducing power consumption during operation. Accelerometers are often made using a small thin plastic land grid array package (LGA) and can operate in an extended temperature range such as from −40 to 85 degree Celsius. Thus, such accelerometers allow for a target 105 to be monitored during storage in climate controlled environments, such as a panty, refrigerator, or freezer.

A further sensor used in this illustrative embodiment is a compass 206 or magnetometer. A compass 206 is a magnetic sensor which detects changes in orientation of a goods target 105. The compass 206 can be used to detect motion 202 by the consumer when the target 105 is moved with respect to orientation and, therefore, likely undergoing a consumption event.

The label 104 may also include, alone, or in coordination with other sensors, a gyroscope 208. Gyroscopes measure angular displacement/velocity of the target 105 in 3 dimensions. The gyroscope 208 can detect and describe digitally, information regarding the consumer's gesture(s) during a consumption event. Available MEMS gyroscopes may be implemented as small surface mounted electronic components that are low-power and energy efficient. They can work in extreme temperature and humidity environments.

The system and method illustrated in FIG. 2 monitors the target 105 using a label 104 including at least one motion sensor such as accelerometer 204, compass 206, or gyroscope 208. The label 104 may check periodically if a motion of the target 105 has been detected. If no motion of the target 105 has been detected, the system returns to the start point 200.

As the label 104 detects motion, it may send the detected motion information to a signal accumulator 212 to buffer 210 the signal detection(s) and information (e.g. information relating to the consumption event). The buffer 210 may wait for further signals to accumulate and thus develop a sequence of motion signals aligned to a specific set of timestamps. A pattern recognition processor 216 may analyze the signal(s) and compare the data with listed indicators of a gesture 214. The comparison of the buffer signal(s) with a pre-configured, e.g., stored library of gestures, can take different forms and implementations such as using various distance measurements. If the system determines no gesture was detected 218, the system returns to the start point 200. If the system determines a gesture was detected 220, the system adds the data to the model for processing 222. The system continues to monitor the target 224 for additional gestures.

Table 1, below, illustrates examples of the types of sensors discussed. A reference for each sensor type is also provided with information on approximate cost, packaging size, operating temperature, and power consumption rate.

TABLE 1
Motion Sensors and Attributes

| | | | | | | Operational | Current | |
|---|---|---|---|---|---|---|---|---|
| | Motion | | | Cost@ | Packaging/ | Temp. | Consumption | |
| Type | Detected | Part Ref. | Axis | 10K | Size | Range | Low power | |
| Accelerometer | Linear | LIS3DH | 3 | US$0.5 | LGA | −40-85° C. | 0.5 | uA |
| | acceleration | | | | 3*3*1 Mm | | | |
| Gyroscope | Angular | L3GD20 | 3 | US$1.5 | LGA | −40-85° C. | 5 | uA |
| | velocity | | | | 3*3*1 Mm | | | |
| Compass | Orientation | IIS2MDC | 3 | US$1.1 | LGA | −40-85° C. | 25 | uA |
| | | | | | 2*2*0.7 mm | | | |

A combination of multiple motion sensors, such as an accelerometer 204, compass 206, and gyroscope 208 may be used to provide accurate detection and shield against noise resulting in a false positive/negative recognition. Alternatively, one type of sensor may be used alone. The state-of-the-art MEMS technology makes it possible to allow the label 104 to include all 3 types of motion sensors to achieve a higher degree of recognition accuracy, all at a low level of total cost, combined power budget and relatively small footprint.

### Gesture Recognition

A valid consumption event from a consumer is typically correlated with at least one gesture by the consumer for accessing, retrieving and/or returning the goods target 105 or its container. Because the label 104 is attached to (or integrated with) the goods target 105, the system can detect and recognize a gesture or set of gestures, each characterized by patterns of linear accelerations, orientations, angular displacement/speed as well as changes of these quantities, for each type of goods, for an individual consumer. As mentioned above, the definition of these gestures and their corresponding sensory description may be configured into the label 104 (e.g., in the form of a gesture table with characteristic accelerations, orientations and/or angular displacements, or the like, defining particular gestures or consumption events). A consumer however, can override this default set of gestures by providing an individualized set of gesture definitions, for a specific goods target 105 under their profile.

At the start of a defined time interval (e.g. every second) 200, the system checks 202 to see if there has been a significant change in orientation, acceleration or angular velocity from the motion sensors, such as the accelerometer 204, compass 206, or gyroscope 208. It should be appreciated by those skilled in the art that as an alternative to the system checking to see if there has been motion sensor activity, that the labels may be configured to periodically transmit information from the sensor(s). If there was no change, the system returns to the origin 200. If a significant change was detected from one or more of these quantities, this may be the onset of a consumption event and the change is first written to a buffer 210 by the signal accumulator 212. The signal accumulator 212 may wait for further signals to accumulate and thus contain a sequence of motion signals at a specific set of timestamps. The buffer 210 is then examined 214 by a pattern recognition processor 216 to see if a defined signal pattern representing a pre-configured gesture is matched.

The comparison of the buffer signal(s) with a pre-configured gesture can take different forms and implementations such as using various distance measurements. A measurement may be preferred based on the defined gesture to be recognized, computational complexity, and memory requirements. Other gestures may use different measurements to determine similarity. A lookup table containing all pre-configured gestures may be stored on a server 102 or the label 104. The lookup table may be used and a gesture with a similarity score passing a defined threshold may be considered a positive detection 220. If no gesture in the lookup table matches the current buffer and no gesture is detected 218, the system returns to its origin 200 and is ready to process again in the next second or time period. If a pattern is recognized, the recognized gesture is sent to a ruleset to determine if a consumption event can be sufficiently determined 222. Sometimes a consumption event requires more than one matching gesture, rather, a sequence of gestures performed over time. After a positive match, the system then resets 224 the signal accumulator 212 and returns to its original state 200 and is ready to start again in the next time period.

Table 2 provides an example of pre-configured gestures in a consumption event with the corresponding signal descriptions for a relevant motion sensor. By way of example, Table 2 describes gestures typically associated with use or consumption of washing machine laundry detergent, however, it should be appreciated that this is only an example illustrating a consumption event. In this illustration, consumer A opens the lid of the detergent bottle, lifts the bottle, and pours the detergent into the washing machine's drawer. This sequence of gestures, collectively performed during a typical consumption event, are defined in the following table and may be pre-configured onto the label 104 if, as in this example, the connected target 105 is identified as laundry detergent.

TABLE 2
Gestures and associated measurements

| # | | | |
|---|---|---|---|
| Pattern | Text Description | Sensors Used | Signal Description |
| 1 | Unscrewing, then | Compass | Orientation change of |
| | screwing of lid | | at least 180 degrees |
| | | | followed by a reverse |
| | | | change of at least 90 |
| | | | degrees within 1 minutes, |
| | | | assume label is attached |
| | | | to the lid. |
| 2 | Upward | Accelerometer | Upwards acceleration |
| | acceleration of the | | beyond certain |
| | bottle while the | | thresholds for a |
| | consumer is lifting | | minimal period of |
| | it up | | 200 ms |
| 3 | Tilting/un-tilting of | Gyroscope | Significant gravity |
| | the bottle | | vectors change for 2 |
| | | | of the 3 axis (tilting). |
| | | | Shortly after that |
| | | | the vectors revert to |
| | | | their original values |
| | | | (un-tilting). |

In practice, a detergent bottle may have a screw lid or a flip lid. Sometimes, it may not have a removable lid at all. The label 104 may be attached to, for example, the lid or the body of the bottle (e.g. on its neck or handle) at the choice of the consumer. Depending on the configuration, a version of the label 104 may only have the accelerometer equipped or multiple types of sensors equipped. A rule set is therefore designed to accommodate these different cases and decide if a gesture, or sequence of gestures, warrants a valid consumption event.

Table 3 is an example of an exemplary rule set which assumes an accelerometer sensor onboard and the optional presence of a gyroscope or compass. Table 3 is an exemplary embodiment and is provided only by way of example. A more complex rule set may be used, and different rule sets can be specified and used for different goods types without deviating from the disclosure.

TABLE 3
Motion Sensors and Attributes

| Steps | Evaluation/Statement | True | False |
|---|---|---|---|
| 1 | Is pattern #2 detected? | Go to step 2 | Go to step A |
| 2 | Is the label equipped with compass? | Go to step 3 | Go to step 4 |
| 3 | Is pattern #1 detected? | Go to step B | Go to step A |
| 4 | Is the label equipped with gyroscope? | Go to step 5 | Go to step B |
| 5 | Is pattern #3 is detected? | Go to step B | Go to step A |
| A | Decision: No, not valid consumption | | |
| | event | | |
| B | Decision: Yes, consumption event | | |
| | detected | | |

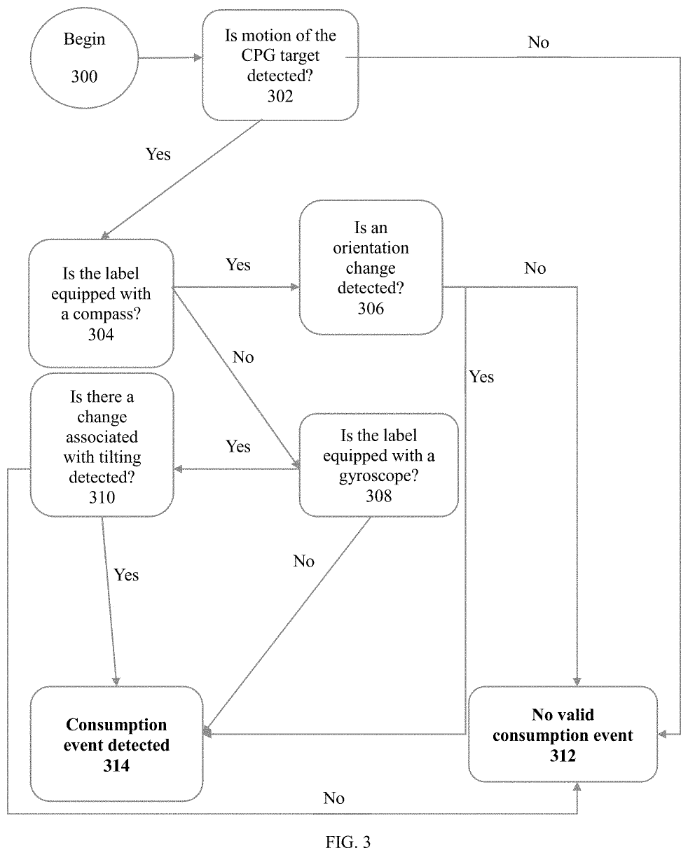

FIG. 3 illustrates a process flow diagram for the detection of a consumption event as described in Table 3. At the start of a defined time interval (e.g. every second) 300, the system checks 302 to see if there has been a significant change in orientation 306 or angular velocity 310 from the motion sensors, such as, for example, the compass 304 or gyroscope 308. If no change is detected, the system returns that no consumption event has occurred 312. If a change is detected from one or more of these quantities, this may indicate the onset of a consumption event 314.

### Depletion Prediction

An illustrative depletion prediction model describing the relationship between a consumption event and a quantity remaining of a good (as a percentage) is described herein. Different models may be used for different CPG targets 105. The server 102 may maintain multiple models and, depending on the consumer's preference and behavioral changes, use at least one model to perform a prediction regarding the consumption of a goods target 105.

Each good(s) depletion prediction characteristics consist of a set of parameters and variables. The respective parameters and variables represent the present state of the CPG target 105. For example, the variables may include the time since the beginning of a tracking session, the accumulated number of consumption events detected in the present tracking session, as well as the time elapsed between past consumption events. A depletion prediction parameter is a coefficient that relates the variables with an output state, such as the quantity of the target good remaining as a percentage.

In a tracking session, the label 104 may continuously feed sensory information to the server 102, including the elapsed time since the beginning of the tracking session, as well as details on recognized consumption events, and other information such as the time stamps of the consumption events. The information may be used to immediately update the depletion prediction model's state running on the server 102. The parameters are not changed during a tracking session. The model parameters are updated after a tracking session comes to an end. While a depletion prediction model is running, a prediction can be performed from the model's current state, by following the model and arriving at a level of predicted quantity remaining of the target 105.

A simpler model may be easier to implement and easier to estimate for its parameters but can suffer from a lower degree of accuracy. A more comprehensive model with more parameters and variables may be used for higher precision if desired. The parameters and variables used will depend on the sensors installed on the label 104. The following simple model is shown as an example for a linear relationship between the number of accumulated consumption events and the remaining quantity as a percentage:

R=a+bA+e

where R is the quantity of the CPG target 105 remaining in its container. R may be a percentage. A is the variable representing the number of accumulative consumption events since the beginning of the tracking session. Model parameters a and b are used to determine the amount remaining (R) based on the number of tracking sessions, A. At the start of a tracking session a is the total amount of the CPG target 105 present. An exemplary value for a where the CPG target 105 starts at 100% is 1. The average reduction per consumption event is defined as b. The parameter b may be input by the consumer or estimated based on past consumption events or information retrieved from the server 102. Errors and imprecisions are captured by e. For example, e may capture the error rate in detecting consumer gestures to trigger the recording of a consumption event. A is defined to be 0≤A≤a/b, otherwise R=0%.

This simple model requires estimation of coefficients a, b. If one assumes b is a constant, it can be directly measured from a previously recorded tracking session of the same goods target 105. Once b is known, given state variable A, R can be easily predicted.

Various techniques may be used to improve the model and reduce the error rate. By way of example, one can treat a and b as random variables and apply regression techniques to estimate their values and minimize their mean squared error. Assuming a and b do not change significantly in a defined period of time (e.g. in the past three month time period) during which the consumer's habits and consumption behaviors remain stable, the server 102 can collect historical data on recorded pairs of (R, A) from previously completed tracking sessions of the same CPG target 105. The depletion prediction model may use this data set to estimate the two model parameters.

Table 4 is an example of 5 tracking sessions over a three month period. The recorded pairs of (R, A) in these tracking sessions are:

TABLE 4
Observed historical data for detergent example

| Tracking | | |
|---|---|---|
| Session | Automatic Collection (R, A) | User input (R, A) |
| 1 | (1, 0), (0, 10) | Nil |
| 2 | (1, 0) | (0.5, 6) |
| 3 | (1, 0), (0, 9) | Nil |
| 4 | (1, 0), (0, 11) | Nil |
| 5 | (1, 0), (0, 10) | Nil |

The automatic collection column of Table 4 refers to samples collected during past tracking sessions. In this example, when a tracking session begins, the system assumes R=100% and A=0. When the consumer ends the tracking session, the system assumed the target 105 was fully consumed and therefore R=0%. When a tracking session ends, and the system estimates that the target 105 may not be fully consumed, the system may ask the consumer to enter an estimate of the remaining quantity of the target 105. In the above example, the consumer provided information for tracking session #2 when the goods had 50% quantity left with 6 consumption events. After carrying out linear regression, the estimated model based on the example data is:

R=1.00309−0.0985A

As shown, this example finds that A is 0 when R is approximately 100%. Moreover, each consumption event in this example is roughly a 10% reduction in the overall quantity of the good 105 by looking at the estimated coefficient b. The system can use this estimated model in future consumption events.

By way of further example, suppose in the next detergent tracking session, there are 8 consumption events by the same consumer. If all conditions are assumed equal to the above example, the quantity remaining is predicted to be 1.00309−0.0985*8=21.5%. Given an average length of a tracking session (in time units) from this consumer for detergent in the last three months T, the time left until the detergent is completely depleted is roughly 0.215T.

Additionally, where the label 104 includes environmental sensors, the label 104 may record the holding conditions of the target 105. The server 102 may evaluate and determine the projected expiration time for the target 105 using the holding conditions of the target 105 compared to the optimal holding conditions. The server 102 may store the predicted remaining life of the target 105 as Tz. As the tracking session proceeds, the server 102 may update a model for predicting when the target 105 will expire.

The parameters of the depletion prediction model are frequently updated and revised by the system. For example, if a CPG target 105 is ice cream, the coefficient b may be smaller during the Winter than during the Summer. When the household size changes, coefficient b will likely change as well. Therefore, the system may re-calibrate itself using recent inputs from the sensors and the consumer, as well as data available from the server 102, to maintain a high degree of accuracy. The system can re-estimate the model parameters shortly after the end of a tracking session using the updated data. The calibrated model may be used in a new tracking session

The above examples are merely illustrative of specific model constructions in the application of goods depletion prediction with gesture detection. In practice, more than one model may be constructed and evaluated to yield more accurate prediction results. The server 102 has the capability of tracking data and estimating multiple models at the same time, yet one model may be used for the prediction at a specific time based on its assessment. The server 102 may self-calibrate and continuously estimate automatically.

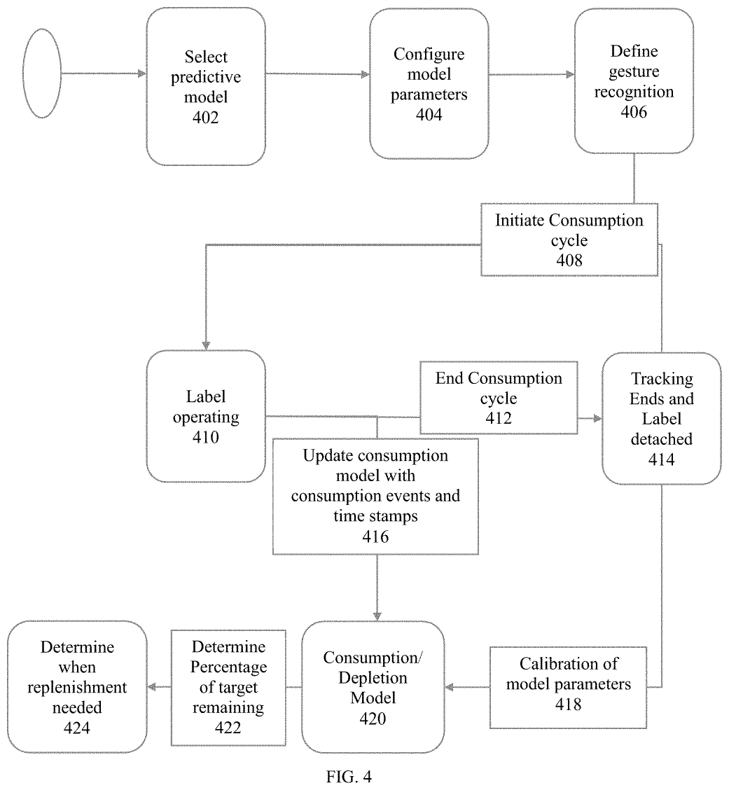

FIG. 4 illustrates a process flow diagram for monitoring a CPG target 105 and determining when the CPG target 105 will require replenishment 424. The system selects a depletion prediction model 402 for a specific target 105. The depletion prediction model may develop the parameters 404 associated with the CPG target 105 using past consumption history stored on the server 102 or using data input by the consumer. The label 104 may use a preconfigured list to determine 406 how to recognize gestures associated with consumption events of the target 105. The label 104 is connected to the target 105 and the tracking session is initiated 408.

In operation, the label 104 tracks 410 the consumption events of the target 105 during the tracking session. The label 104 updates 416 the depletion prediction model with consumption events and associated time stamps during the tracking session. The consumer may end the tracking session 412. The label 104 ends tracking 414 when R is estimated to equal 0 or the consumer ends the tracking session 412. The model updates the parameters (e.g., for model calibration) based on the tracking session data 418. The consumption/depletion model runs 420 to determine the estimated R value (i.e., the percentage of the target good remaining) 422. The model determines 424 when restocking/replenishment is needed (for example, when a threshold level set for replenishment is reached). If the model determines a restock/replenishment is needed, it may place an order with a vendor to restock/replenish the target 104. The server 102 may issue an alert, such as via Short Messaging Service (SMS), Enhanced Message Service (EMS), Multimedia Messaging Service (MMS), Instant Messaging, eMail notification or the like, to the consumer and/or the vendor when the model determines a restock/replenishment is needed.

In parallel, a calibration process may be started to allow a consumer to provide a set of gestures most likely used in a typical consumption event. The motion sensors can record these pre-configured gestures with thresholds such as those described in Table 3. After initial estimates of the model parameters are obtained, the parameters can be used to perform prediction in a live tracking session. While a tracking session is ongoing, the motion sensors such as the accelerometer 204, compass 206, and gyroscope 208 are used to detect consumption events using a ruleset by identifying a set of pre-defined gestures performed over time. As the tracking proceeds, the server 102 updates its model variables with information on consumption events and their timestamp. The server 102 performs prediction using the model to derive the time left until the CPG target becomes completely depleted (or reaches a threshold level of depletion). At the end of a tracking session, the model performs self-calibration of its parameters based on information it records as well as any consumer inputs. After calibration, the updated model is ready for another tracking session. The process is iterative.

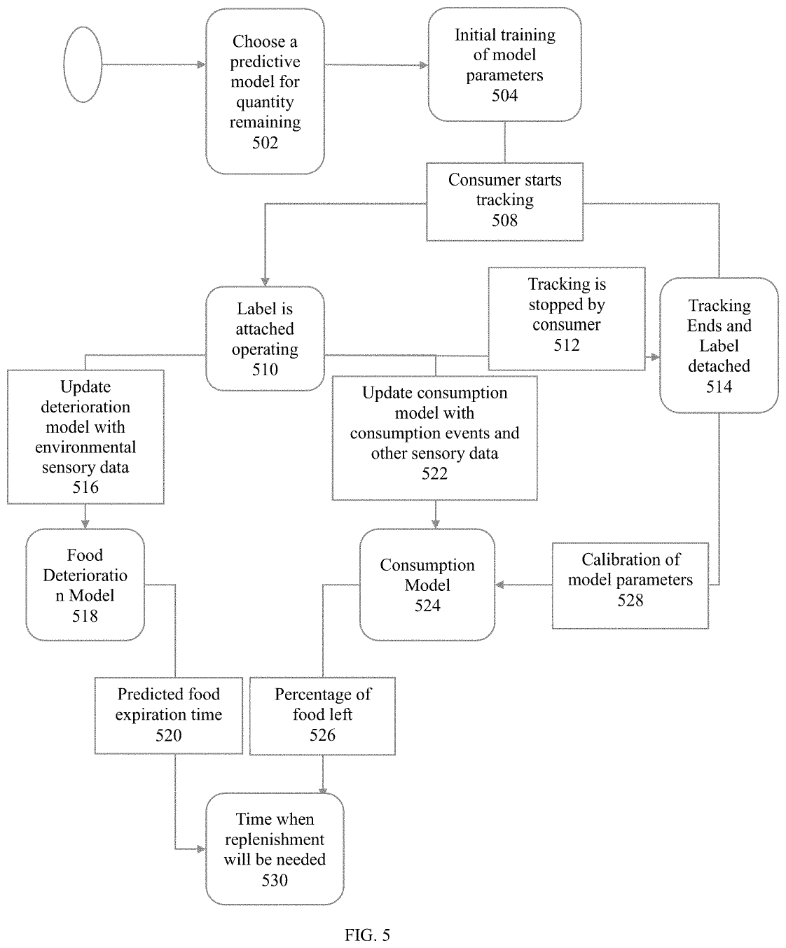

FIG. 5 illustrates a process flow diagram for monitoring the quantity and quality of a CPG target 105 according to the disclosure. The system selects a depletion prediction model 502 for a specific target 105. The model may develop the parameters 504 associated with the CPG target 105 using past consumption history stored on the server 102 or using data input by the consumer (e.g., training). The label 104 is connected to the target 105 and the tracking session is initiated 508, for example by the consumer. The label begins the tracking session 510. The consumer may end a tracking session 512. The label may be detached from the target 514 and the model parameters calibrated 528 using the session data.

The label 104 tracks 510 the environmental conditions 516 and the consumption events 522 of the target 105 during the tracking session. The label 104 or the server 102 may run multiple models, including a quality model for tracking the target's 105 quality 518 and a depletion prediction model for monitoring the target's 105 remaining quantity 524. The target's 105 expiration 520 is estimated by the quality model 518. The target's remaining quantity 526 is estimated by the quantity model 524. The system determines 530 when restocking/replenishment is needed using the values calculated for the target's estimated expiration 520 and/or depletion 526. If the system determines a restock/replenishment is needed, it may place an order with a vendor to restock/replenish the target 104. The server 102 may issue an alert to the consumer and/or the vendor when the model determines a restock/replenishment is needed.

Although an illustrative server is described in embodiments herein it should be appreciated that processing for depletion prediction and quality monitoring as described herein may be implemented by a microcontroller in program code, for example configured in an appliance such as a refrigerator, freezer, storage cabinet or the like, and it should be appreciated by those skilled in the art that discrete control electronics, large scale integrated circuitry or other control technologies may be used to implement the functionality described herein.

Although illustrative sensors are disclosed in the embodiments here, including an accelerometer, a compass, and/or a gyroscope for monitoring gestures or consumption events, it should be appreciated that other types of sensors may be implemented according to the disclosure, such as ultrasonic, vibration sensors, Infrared sensors, microwave sensors or the like.

While various embodiments are disclosed herein, it should be understood that the disclosure is not so limited and modifications may be made without departing from the disclosure. The scope of the disclosure is defined by the appended claims, and all devices that come within the meaning of the claims, either literally or by equivalence, are intended to be embraced therein.

What is claimed is:

1. A method of monitoring the remaining quantity of a consumer good, the method comprising steps of:
attaching a label including at least one motion sensor to a consumer good;
configuring the label to recognize gestures associated with a consumption event of the consumer good;
beginning a tracking session using the at least one motion sensor to detect movement of the consumer good to monitor the gestures associated with the consumption event of the consumer good;
providing information from the at least one motion sensor included on the label to a depletion prediction model configured to determine a remaining quantity of the consumer good;
determining if the movement is a recognized gesture associated with the consumption event of the consumer good; and
predicting the remaining quantity of the consumer good based on the consumption event of the consumer good.

2. The method of monitoring the remaining quantity of the consumer good of claim 1 further comprising:
receiving a signal from the at least one motion sensor;
buffering the signal;
comparing the signal with a pre-configured list of gestures associated with the consumption event of the consumer good; and
determining whether a recognized gesture associated with the consumption event of the consumer good has been detected.

3. The method of monitoring the remaining quantity of the consumer good of claim 1 further comprising:
updating the depletion prediction model configured to determine a remaining quantity of the consumer good model with the consumption event and an associated timestamp.

4. The method of monitoring the remaining quantity of the consumer good of claim 1 further comprising:
alerting a consumer of the remaining quantity of the consumer good.

5. The method of monitoring the remaining quantity of the consumer good of claim 1 further comprising:
predicting when the consumer good will be depleted;
generating an order to replenish the consumer good; and
notifying a vendor to replenish the consumer good.

6. The method of monitoring the remaining quantity of the consumer good of claim 5 further comprising:
ordering to replenish the consumer good before the consumer good is fully depleted.

7. The method of monitoring the remaining quantity of the consumer good of claim 1 further comprising:
ending the tracking session of the consumer good;
updating the model with an elapsed time for the tracking session and a number of the consumption events which occurred during the tracking session; and
calibrating the depletion prediction model.

8. The method of monitoring the remaining quantity of the consumer good of claim 1 wherein the at least one motion sensor is selected from a group consisting of an accelerometer, a compass, and a gyroscope.

9. The method of monitoring the remaining quantity of the consumer good of claim 1 further comprising the steps of:
determining a coefficient for the depletion rate of the consumer good per consumption event;
determining an average length of a tracking session of the consumer good;
predicting an estimated time remaining before the consumer good is depleted; and
placing an order to replenish the consumer good before the consumer good is estimated to be depleted.

10. A system for monitoring the remaining quantity of a consumer good comprising:
a server;
at least one depletion prediction model configured to predict a remaining quantity of the consumer good, the at least one depletion prediction model running on the server, including at least one parameter representing the remaining quantity of the consumer good;
at least one label disposed on the at least one consumer good, the at least one label comprising at least one motion sensor and configured to detect a movement of the at least one consumer good and generate a signal from the at least one motion sensor;
a signal accumulator operatively connected to the at least one motion sensor, the signal accumulator configured to receive the signal from the at least one motion sensor; and
a pattern recognition processor configured to compare the signal from the at least one motion sensor to a pre-configured table defining movements associated with a consumption event.

11. The system for monitoring the remaining quantity of the at least one consumer good of claim 10 further comprising:
a consumer device operatively connected to the server;
the consumer device configured to instruct the server to begin or end a tracking session; and
the consumer device further configured to receive an alert from the server, the alert comprising the remaining quantity of the at least one consumer good.

12. The system for monitoring the remaining quantity of the at least one consumer good of claim 11 wherein the server is configured to calibrate the model after a tracking session ends.

13. The system for monitoring the remaining quantity of the at least one consumer good of claim 11 wherein the server is configured to send an alert to a vendor to replenish the consumer good when the at least one depletion prediction model predicts the consumer good needs to be replenished.

14. The system for monitoring the remaining quantity of the at least one consumer good of claim 11 wherein the label is configured to communicate with the server to update the at least one depletion prediction model when the pattern recognition processor detects the consumption event has occurred.

15. A label system for monitoring the remaining quantity of a consumer good comprising:
at least one motion sensor integrated with the consumer good;
a pattern recognition processor operatively connected to the at least one motion sensor, the pattern recognition processor configured to receive at least one signal from the at least one motion sensor and determine if a consumption event has occurred;
a depletion prediction model for predicting the remaining quantity of the consumer good, the depletion prediction model configured to update when the pattern recognition processor determines a consumption event has occurred.

16. The label system for monitoring the remaining quantity of the consumer good of claim 15 wherein the depletion prediction model outputs an alert including a predicted remaining quantity of the consumer good.

17. The label system for monitoring the remaining quantity of the consumer good of claim 16 wherein the alert is received by the consumer on a consumer device.

18. The label system for monitoring the remaining quantity of the consumer good of claim 16 wherein the label is configured to send a replenishment notification to a vendor when the quantity of the consumer good needs to be replenished.

19. The label system for monitoring the remaining quantity of the consumer good of claim 16 wherein the label is configured to create a replenishment notification to replenish the consumer good before the time the depletion prediction model predicts the consumer good will be depleted.

20. The label system for monitoring the remaining quantity of the consumer good of claim 15 wherein the at least one sensor is selected from a group of sensors consisting of an accelerometer, a compass, and a gyroscope.
